(19) United States
(12) Patent Application Publication
(10) Pub. No.: US 2010/0120285 A1
(43) Pub. Date: May 13, 2010

(54) CABLE ASSEMBLY WITH DUSTPROOF COVER

(75) Inventors: YONG-JUN CHEN, Shenzhen (CN); XIAN-KUI SHI, Shenzhen (CN); JIN-ZHI CHEN, ShenZhen (CN); CHUNG-YEN YANG, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Taipei Hsien (TW)

(21) Appl. No.: 12/616,794

(22) Filed: Nov. 12, 2009

(30) Foreign Application Priority Data
Nov. 12, 2008 (CN) 200810305508.7

(51) Int. Cl. H01R 13/52

(52) U.S. Cl. 439/521

(57) ABSTRACT

A cable assembly with at least one dustproof cover, comprises a first connector with a first locking member thereon, a second connector with a second locking member thereon and paralleled with first connector. A cable is electrically connected with the first and second connectors and vertical with the first and second connectors. A first dustproof cover is covered to the first connector and enclosing the first locking member. And a second dustproof cover is covered to the second connector and enclosing the second locking member.

### FIELD OF THE INVENTION

The present invention relates to cable assembly, particularly to a cable assembly with dustproof cover for protecting a portion of the cable assembly effectively.

### DESCRIPTION OF PRIOR ART

Dustproof cover are widely applied to the cable assembly in order to protect an interface of a connector before its interconnection with a mating connector from being contaminated by dust particles, moisture and other substances to ensure a good performance of information transmission. U.S. Pat. No. 7,534,132 B2 issued on May 19, 2009 discloses a dustproof cover fitted to a mating portion of the cable assembly, when the cable assembly is in use, the dustproof cover should be removed. Further, U.S. Pat. No. 6,896,540 B1 issued on May 24, 2005 discloses a cable assembly with a latch on an outer surface of a housing of the cable assembly without protection, so when the cable assembly is not in use, the latch of the cable assembly will be distorted or damaged by outer force easily.

As discussed above, an improved cable assembly overcoming the shortages of existing technology is needed.

### SUMMARY OF THE INVENTION

Accordingly, an object of the present invention is to provide a cable assembly with at least one dustproof cover for protecting a mating surface of the insulative housing of the cable assembly and a locking member attached to the insulative housing of the cable assembly.

In order to achieve the above-mentioned objects, a cable assembly with at least one dustproof cover comprises a first connector with a first locking member thereon; a second connector with a second locking member thereon and paralleled with first connector; a cable electrically connected with the first and second connectors and vertical with the first and second connectors; a first dustproof cover covered to the first connector and enclosing the first locking member; and a second dustproof cover covered to the second connector and enclosing the second locking member.

Other objects, features and advantages of the invention will be apparent from the following detailed description taken in connection with the accompanying drawings.

### BRIEF DESCRIPTION OF THE DRAWINGS

FIG. 1 is a perspective view of a cable assembly in accordance with the present invention, and a first and second dustproof covers are respectively covered to a first and second connectors of the cable assembly;

FIG. 2 is a perspective view of a cable assembly in accordance with the present invention, and the first and second of dustproof covers are not covered to the first and second connectors of the cable assembly;

FIG. 3 is similar to FIG. 2, but viewed from another aspect;

FIG. 4 is a perspective view of the first dustproof cover;

FIG. 5 is a perspective view of the second dustproof cover;

FIG. 6 is similar to FIG. 5, but viewed from another aspect.

### DETAILED DESCRIPTION OF PREFERRED EMBODIMENTS

Reference will now be made to the drawing figures to describe the present invention in detail.

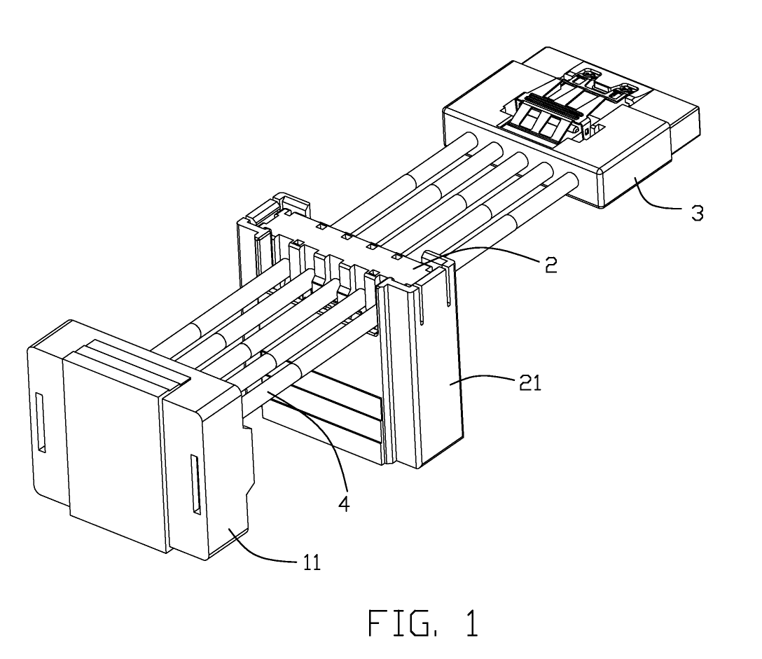

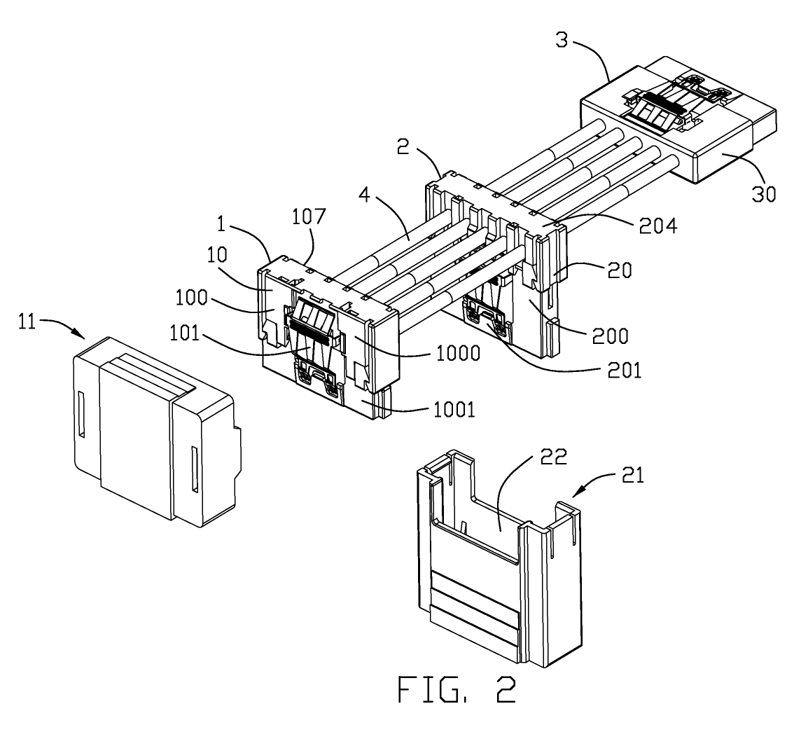

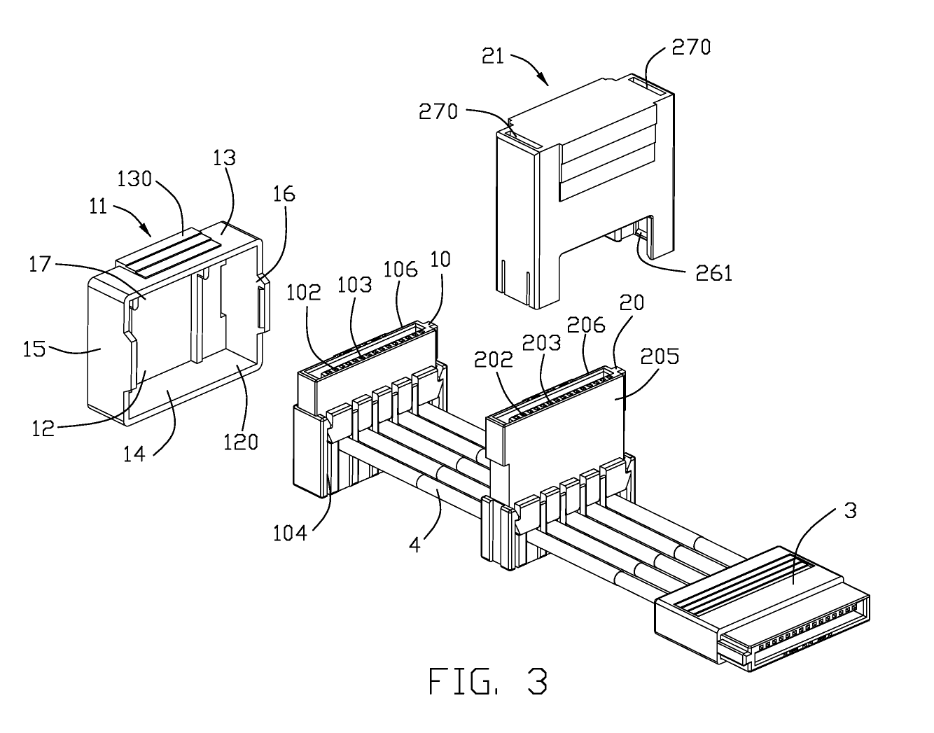

Referring to FIGS. 1 to 3, a cable assembly with at least one dustproof cover made in accordance with the present invention, generally designated 100, is adapted for mating with a plurality of complementary connectors (not shown). The cable assembly 100 defines a first connector 1, a second connector 2, a third connector and a cable 4 electrically connected with the first, second and third connectors 1, 2, 3. In addition, a first and second dustproof covers 11, 21 are respectively assembled to the first and second connectors 1, 2. The first and second connector 1, 2 are paralleled with each other. The third connector 3 is vertical with the first or second connector 1, 2. The first, second and third connectors 1, 2, 3 are all Serial ATA Plug Connectors.

The first connector 11 defines a first insulative housing 10 having a plurality of terminal receiving passageways 102 therein, a plurality of first terminals 103 respectively received into the corresponding terminal receiving passageways 102 and a first locking member 101 attached to a top surface 100 of the first insulative housing 10. The top surface 100 is a step surface included by a first surface 1000 and a second surface 1001 lower than the first surface 1000. The first insulative housing 10 further defines a bottom surface 104 opposite to the top surface 100, a mating surface 106 and a rear surface 107 opposite to the mating surface 106. The first locking member 101 is stamped and formed from a metallic plate. And, the first connector 1 is locked with and discreted from the complementary connector (not shown) through pushing down and releasing the first locking member 101.

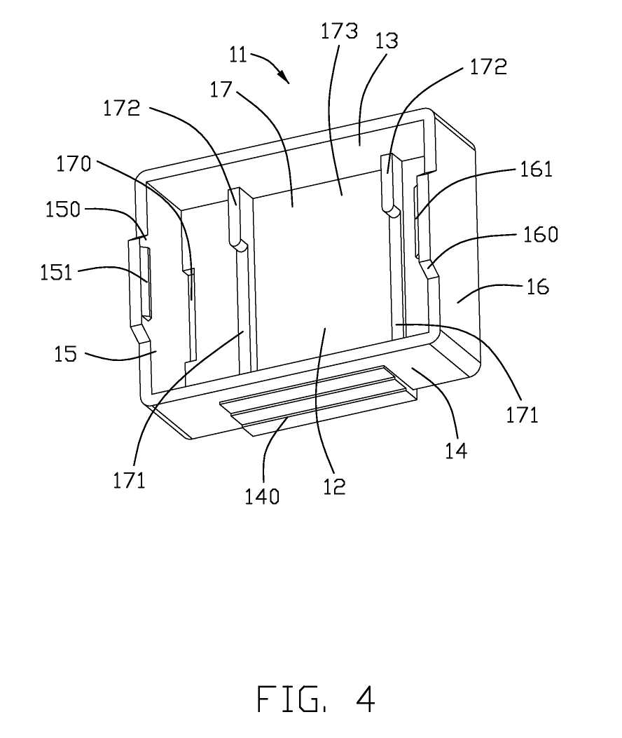

Referring to FIGS. 1 to 3 and in conjunction with FIG. 4, the first dustproof cover 11 of the cable assembly 100 is formed of insulative material and defines four side walls 13, 14, 15, 16 connected with each other and a bottom wall 17 connecting with respective edges of the four side walls 13, 14, 15, 16. A receiving room 12 is enclosed by four side walls 13, 14, 15, 16 and the bottom wall 17 and defines an opening 120 for the first connector 1 entered into the receiving room 12. Each side wall 15, 16 defines a latch 150, 160 for latching with the first insulative housing 10 of the first connector 1. The latch 150, 160 respectively defines an engaging section 151, 161 formed on an inner surface of the latch 150, 160. The bottom wall 17 defines a pair of through holes 170 for forming the pair engaging portions 151, 161 conveniently and easily. Two spaced and paralleled ribs 171 are formed on an inner surface of the bottom wall 17 and extend into the receiving room 12 toward the opening 120. Furtherly, each rib 171 defines a protruding portion 172 disposed on one side of the rib 171 and extending toward the opening 120. Thus, each rib 171 is in a step shape. A receiving cavity 173 are formed between the two spaced ribs 171 and the bottom wall 17 for receiving a portion of the first locking member 101. Each side wall 13, 14 respectively defines a step protrusion 130, 140 on an outer surface thereof, so the user can grasp the first dustproof cover 11 easily.

Referring to FIGS. 1 to 3 and in conjunction with FIG. 4, the receiving room 12 of the first dustproof cover 11 has a size equal to that of the first insulative housing 10, so the first insulative housing 10 can be received into the receiving room 12 of the first dustproof cover 11 properly. And the receiving cavity 173 of receiving room 12 of the dustproof cover 11 has enough space for receiving a portion of the first locking member 101 located upper the top surface 100 of the first insulative housing 10 of the first connector 1. When the dustproof cover 11 is covered to the first insulative housing 10 of the first connector 1, the two step shaped ribs 171 are respectively attached to the corresponding step shaped top surface 100 of the first insulative housing 10. And the portion of the first locking member 101 located upper the top surface 100 of the first insulative housing 10 of the first connector 1 is received into the receiving cavity 173. In other word, the first locking member 101 are completely protected by the dustproof cover 11, so the first locking member 101 will not be distorted or damaged by outer force easily. And the mating surface 106 of the first insulative housing 10 is also shielded by the side wall 13 to protect from being contaminated by dust particles, moisture and other substances to ensure a good performance of information transmission. At the same time, the engaging sections 151, 161 of the latches 150, 160 are engaged with the bottom surface 104 of the first insulative housing 10. Thus, the engagement between the first dustproof cover 11 and the first connector 1 is finished. If the first connector 1 is to be used, the dustproof cover 11 should be removed from first connector 1 in advance.

Referring to FIGS. 1 to 3, the second connector 2 defines a second insulative housing 20 having a plurality of terminal receiving passageways 202 therein, a plurality of second terminals 203 respectively received into the corresponding terminal receiving passageways 202 and a second locking member 201 attached to a top surface 200 of the second insulative housing 20. The second insulative housing 20 further defines a bottom surface 205 opposite to the top surface 200, a mating surface 206 and a rear surface 204 opposite to each other. The second locking member 201 is stamped and formed from a metallic plate and defines a portion upper the top surface 200 of the second insulative housing 20. The second connector 2 is locked with and discreted from the complementary connector (not shown) through pushing down and releasing the second locking member 201.

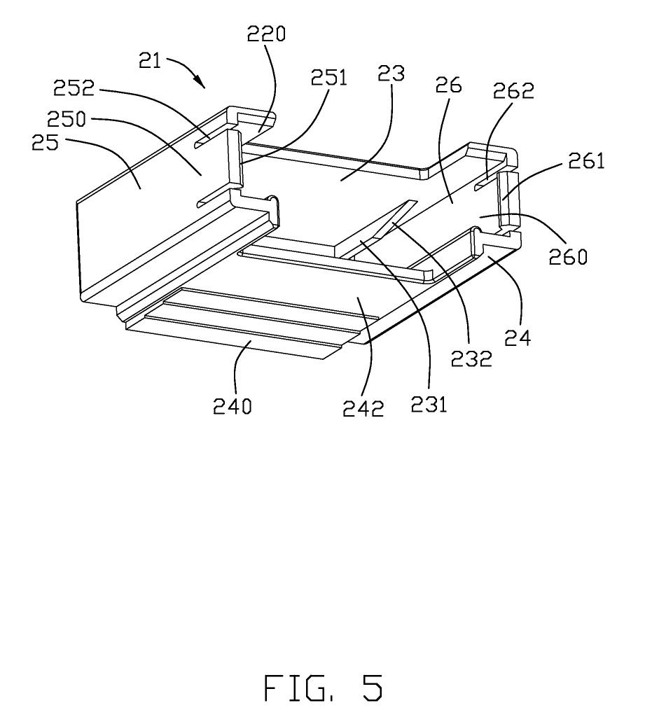

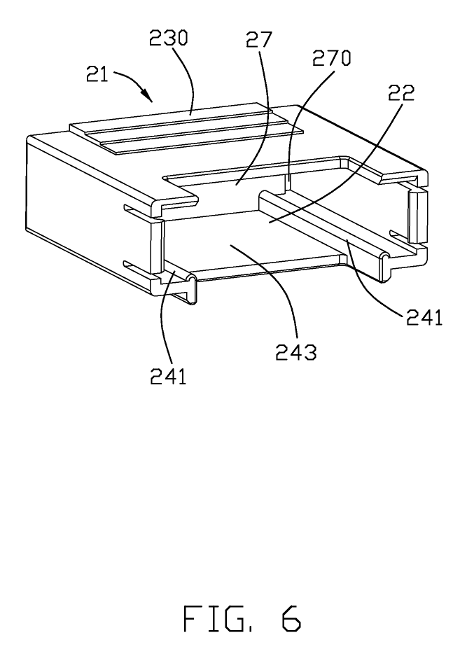

Referring to FIGS. 1 to 3 and in conjunction with FIGS. 5 and 6, a second dustproof cover 21 of the cable assembly 100 is also formed of insulative material and defines four side walls 23, 24, 25, 26 connected with each other and a bottom wall 27 connecting with one side of the four side walls 23, 24, 25, 26. A receiving room 22 is enclosed by the four side walls 23, 24, 25, 26 and the bottom wall 27 and defines an opening 220 for the second connector 2 entered into the receiving room 22. The side wall 25 defines two paralleled slits 252 disposed at one end thereof and apart from the bottom wall 27. Thus, a latch 250 is formed by the two spaced slits 252. And an engaging section 251 is formed on an inner surface of the latch 250. The side wall 26 also defines two paralleled slits 262 to form a latch 260. The latch 260 also has an engaging section 261 formed on an inner surface of the latch 250. The bottom wall 27 defines a pair of through holes 270 for forming the pair engaging sections 251, 261 conveniently and easily. The side wall 24 defines a bulgy portion 242 in a middle section thereof. And the bulgy portion 242 of the side wall 24 defines a step protrusion 242 on an outer surface thereof for the user grasping the first dustproof cover 21 easily. Two spaced ribs 241 are formed on an inner surface of the side wall 24 to form a receiving channel 243. The side wall 23 also defines two spaced ribs 231 on an inner surface thereof. Each rib 231 defines a chamfer 232 at one end adjacent to the opening 220 of the second dustproof cover 21. The side walls 23, 24 of the second dustproof cover 21 respectively defines a U-shaped cutout (not figured) for the cable 4 passing through when the second dustproof cover 21 is covered to the second connector 2.

Referring to FIGS. 1 to 3 and in conjunction with FIGS. 5 and 6, the receiving room 22 of the second dustproof cover 21 has a size equal to that of the second insulative housing 20 of the second connector 2, so the second insulative housing 20 can be received into the receiving room 22 of the second dustproof cover 21 properly. And the receiving channel 243 of receiving room 22 of the second dustproof cover 21 has enough space for receiving a portion of the second locking member 201 disposed upper the top surface 200 of the second insulative housing 20 of the second connector 2. When the second dustproof cover 21 is fully covered to the second insulative housing 20 of the second connector 2, the two ribs 241 are attached to the corresponding top surface 200 of the second insulative housing 20. And the portion of the second locking member 201 located upper the top surface 200 of the second insulative housing 20 of the second connector 2 is received into the receiving channel 243. In other word, the second locking member 201 are fully protected by the second dustproof cover 21, so the second locking member 201 will not be distorted or damaged by outer force easily. The mating surface 206 of the second insulative housing 20 is also shielded by the bottom wall 27 of the second dustproof cover 21 to protect from being contaminated by dust particles, moisture and other substances to ensure a good performance of information transmission. The engaging sections 251, 261 of the latches 250, 260 are engaged with the rear surface 204 of the second insulative housing 2. Thus, the engagement between the second dustproof cover 21 and the second connector 2 is finished. And the two ribs 231 formed on the side wall 23 are attached to the bottom surface 205 of the second insulative housing 20. Thus, the second connector 2 is fully and steady received into the receiving room 22. If the first connector 2 is to be used, the second dustproof cover 21 should be removed from first connector 2 in advance.

Obviously, the third connector 3 also can be covered by a third dustproof cover (not shown) when the third connector 3 is not in use. A mating surface (not figured) of the third connector 3 and a locking member (not figured) assembled to a third housing 30 can be protected by the third dustproof cover.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A cable assembly with at least one dustproof cover, comprising:
a first connector with a first locking member thereon;
a second connector with a second locking member thereon and paralleled with first connector;
a cable electrically connected with the first and second connectors and vertical with the first and second connectors;
a first dustproof cover covered to the first connector and enclosing the first locking member; and
a second dustproof cover covered to the second connector and enclosing the second locking member.

2. The cable assembly as recited in claim 1, wherein the first connector includes a first insulative housing having a top surface and a mating surface, the first locking member is attached to the top surface of the first insulative housing, the mating surface of the first insulative housing is shielded by the first dustproof cover.

3. The cable assembly as recited in claim 2, wherein the first connector defines a plurality of terminals disposed in the first insulative housing.

4. The cable assembly as recited in claim 2, wherein the first dustproof cover defines four side walls connected with each other and a bottom wall connected with respective edges of the four side walls to form a receiving room, the first insulative housing is received into the receiving room.

5. The cable assembly as recited in claim 4, wherein the bottom wall of the first dustproof cover defines two spaced ribs on an inner surface thereof and attached to the top surface of the first insulative housing, a receiving cavity is formed by the bottom wall and the two spaced ribs, a portion of the first locking member is received into the receiving cavity.

6. The cable assembly as recited in claim 4, wherein two opposite side walls respectively define a latch engaged with the first insulative housing of the first connector.

7. The cable assembly as recited in claim 1, wherein the second connector includes a second insulative housing having a top surface and a mating surface, the second locking member is attached to the top surface of the second insulative housing, the mating surface of the second insulative housing is shielded by the first dustproof cover.

8. The cable assembly as recited in claim 7, wherein the second connector defines a plurality of terminals disposed in the second insulative housing.

9. The cable assembly as recited in claim 7, wherein the second dustproof cover defines four side walls connected with each other and a bottom wall connected with respective edges of the four side walls to form a receiving room, the first insulative housing is received into the receiving room.

10. The cable assembly as recited in claim 9, wherein one side wall of the second dustproof cover defines two spaced ribs on an inner surface thereof and attached to the top surface of the first second housing, a receiving channel is formed by the side wall and the two spaced ribs, a portion of the second locking member is received into the receiving channel.

11. The cable assembly as recited in claim 1, wherein a third connector is electrically connected with the cable, the third connector is vertical with the first and second connectors.

12. A cable assembly with a first and second dustproof cover, comprising:
a cable;
a first connector with a first locking member and electrically connected with one end of the cable;
a third connector electrically connected with another end of the cable and vertical with the first connector;
a second connector with a second locking member, electrically connected with a middle portion of the cable and paralleled with the first connector and vertical with the third connector; and
the first and second dustproof cover respectively enclosing the first and second connector, and the first and second locking member respectively covered by the first and second dustproof cover.

13. The cable assembly as recited in claim 12, wherein the first connector defines a first insulative housing with a top surface and a mating surface vertical with the top surface, the first dustproof cover defines an opening toward to the top surface of the first insulative housing, the mating surface is shielded by a portion of the first dustproof cover.

14. The cable assembly as recited in claim 12, wherein the second connector defines a second insulative housing with a top surface and a mating surface vertical with the top surface, the second dustproof cover defines an opening toward to the mating surface of the second insulative housing, the mating surface is shielded by a portion of the second dustproof cover.

15. A cable connector assembly comprising:
a plurality of wires arranged in a parallel relation;
a first connector having a plurality of first contacts therein and defining a first face with therein a first mating opening through which a first receiving cavity defined in the housing communicates with an exterior, a second face through which said wires extend from the exterior into the first connector to electrically connect the first contacts, respectively, and a third face upon which a deflectable first locking member is seated; and
a first protective cover assembled to the housing and covering at least both said first mating opening and said first locking member; wherein
said first mating opening faces to the exterior in a first direction, and said first deflectable locking member is deflectable in a second direction perpendicular to the first direction.

16. The cable connector assembly as claimed in claim 15, wherein said first protective cover is assembled to the first connector in the direction either perpendicular to or parallel to the wires.

17. The cable connector assembly as claimed in claim 15, wherein said wires further extends through the third face and connects to a second connector.

18. The cable connector assembly as claimed in claim 17, wherein said second connector is similar to the first connector and equipped with a second mating opening facing to the exterior and a second deflectable locking member under condition that both said first connector and said second connector are essentially perpendicular to the wires.

19. The cable connector assembly as claimed in claim 17, wherein said second connector is enclosed by a second protective cover under condition that the first protective cover is assembled to the first connector in a direction perpendicular to said wires while the second protective cover is assembled to the second connector in a direction parallel to said wires.

20. The cable connector assembly as claim 15, wherein said wires are further connected to a second connector which is essentially parallel to the wires.
